(19) United States
(12) Patent Application Publication
(10) Pub. No.: US 2026/0288647 A1
(43) Pub. Date: Sep. 24, 2026

(54) MEMORY HANDLING WITH DELEGATED TASKS

(71) Applicant: Arm Limited, Cambridge (GB)

(72) Inventors: Bo Eyole, Cambridge (GB); Richard Roy Grisenthwaite, Cambridge (GB); Robert Gwilym Dimond, Cambridge (GB); Robin Alexander Emery, Cambridge (GB)

(73) Assignee: Arm Limited, Cambridge (GB)

(21) Appl. No.: 19/490,132

(22) PCT Filed: Mar. 7, 2024
(86) PCT No.: PCT/GB2024/050609

§ 371 Date: Dec. 4, 2025

(30) Foreign Application Priority Data
Jun. 5, 2023 (GB) 2308373.6

(51) Int. Cl. G06F 12/1009; G06F 9/30; G06F 9/38; G06F 12/1027

(52) U.S. Cl. CPC G06F 12/1009; G06F 9/30181; G06F 9/382; G06F 12/1027

(57) ABSTRACT

There is provided an apparatus for data processing. The apparatus includes a data processing pipeline that performs one or more data processing operations and extension processing circuitry associated with the data processing pipeline that performs one or more delegated tasks. Page table walk circuitry performs a page table walk operation on memory in response to either the one or more data processing operations or the one or more delegated tasks. The extension processing circuitry performs the one or more delegated tasks asynchronously to the one or more data processing operations performed by the data processing pipeline.

The present techniques relate to an apparatus, a method of operating an apparatus, a computer program, and a computer-readable medium.

An apparatus may comprise a data processing pipeline configured to perform data processing operations in dependence on a received sequence of instructions as well as an extension processing circuitry associated with the data processing pipeline and configured to set up one or more delegated tasks. It is desirable for the memory management in such a system to be handled efficiently.

Viewed from a first example configuration, there is provided an apparatus for data processing, comprising: a data processing pipeline configured to perform one or more data processing operations; extension processing circuitry associated with the data processing pipeline and configured to perform one or more delegated tasks; and page table walk circuitry configured to perform a page table walk operation on memory in response to either the one or more data processing operations or the one or more delegated tasks, wherein the extension processing circuitry is configured to perform the one or more delegated tasks asynchronously to the one or more data processing operations performed by the data processing pipeline.

Viewed from a second example configuration, there is provided a method of data processing, comprising: performing, on a data processing pipeline, one or more data processing operations; performing, on extension processing circuitry associated with the data processing pipeline, one or more delegated tasks; and performing a page table walk operation on memory in response to either the one or more data processing operations or the one or more delegated tasks, wherein the extension processing circuitry is configured to perform the one or more delegated tasks asynchronously to the one or more data processing operations performed by the data processing pipeline.

Viewed from a third example configuration, there is provided a computer program for controlling a host data processing apparatus to provide an instruction execution environment comprising: data processing pipeline program logic configured to set up one or more data processing operations; extension processing program logic associated with the data processing pipeline program logic and configured to set up one or more delegated tasks; and page table walk program logic, configured to perform a page table walk operation on memory in response to either the one or more data processing operations or the one or more delegated tasks, wherein the extension processing program logic is configured to perform the one or more delegated tasks asynchronously to the one or more data processing operations performed by the data processing pipeline.

Viewed from a fourth example configuration, there is provided a non-transitory computer-readable medium to store computer-readable code for fabrication of an apparatus for data processing, comprising: a data processing pipeline configured to perform one or more data processing operations; extension processing circuitry associated with the data processing pipeline and configured to perform one or more delegated tasks; and page table walk circuitry configured to perform a page table walk operation on memory in response to either the one or more data processing operations or the one or more delegated tasks, wherein the extension processing circuitry is configured to perform the one or more delegated tasks asynchronously to the one or more data processing operations performed by the data processing pipeline.

The present technique will be described further, by way of example only, with reference to embodiments thereof as illustrated in the accompanying drawings, in which:

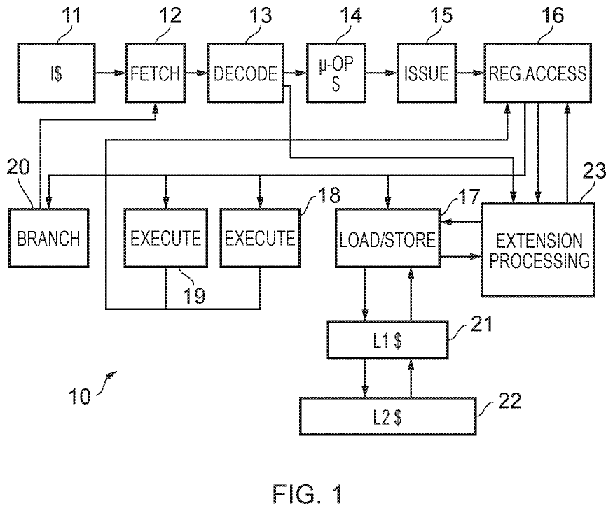

FIG. 1 schematically illustrates a data processing apparatus which may embody various examples of the present techniques;

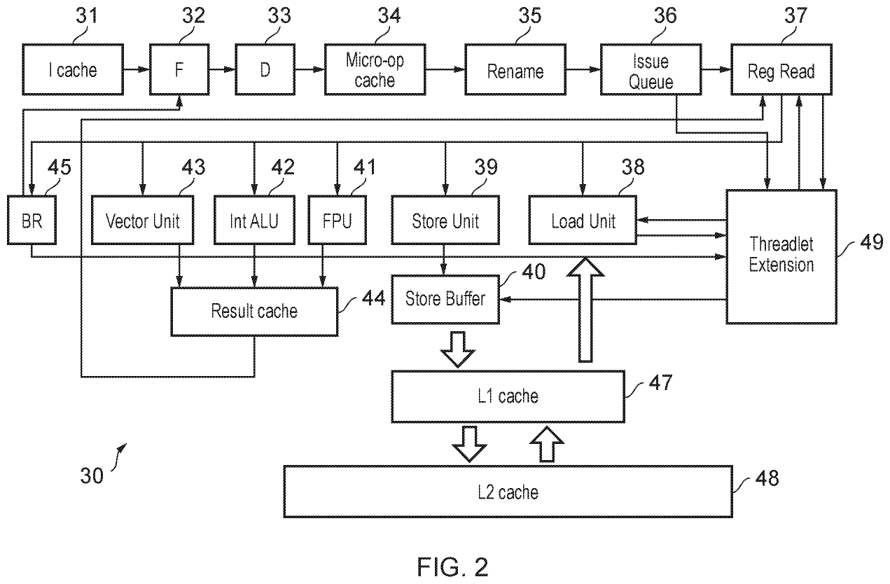

FIG. 2 schematically illustrates a data processing apparatus which may embody various examples of the present techniques;

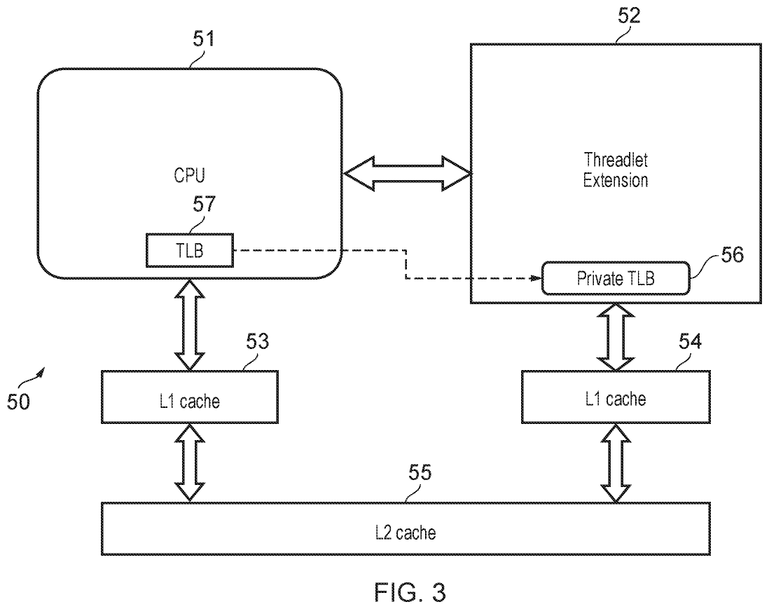

FIG. 3 schematically illustrates a data processing apparatus which may embody various examples of the present techniques;

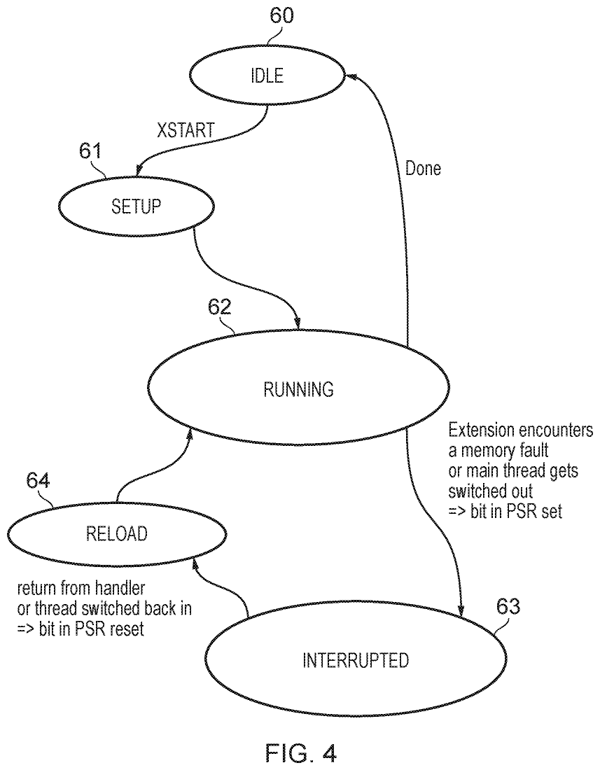

FIG. 4 is a state diagram illustrating an example set of states between which extension processing circuitry of the present techniques may transition;

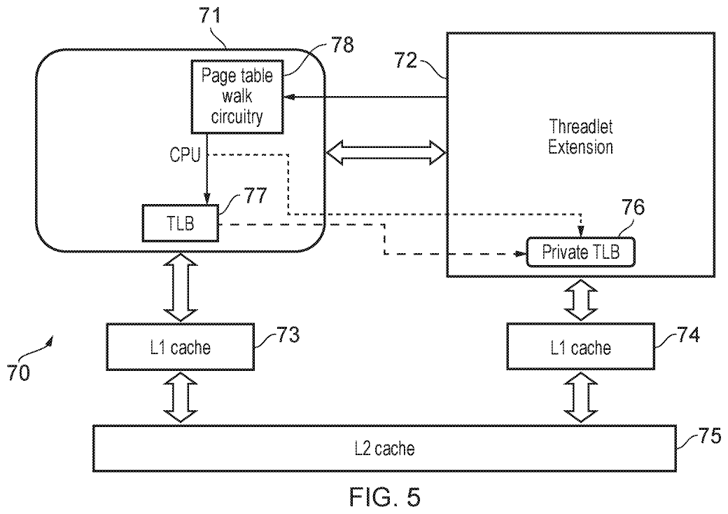

FIG. 5 illustrates a variant of the apparatus previously illustrated in FIG. 3 and may embody various examples of the present techniques;

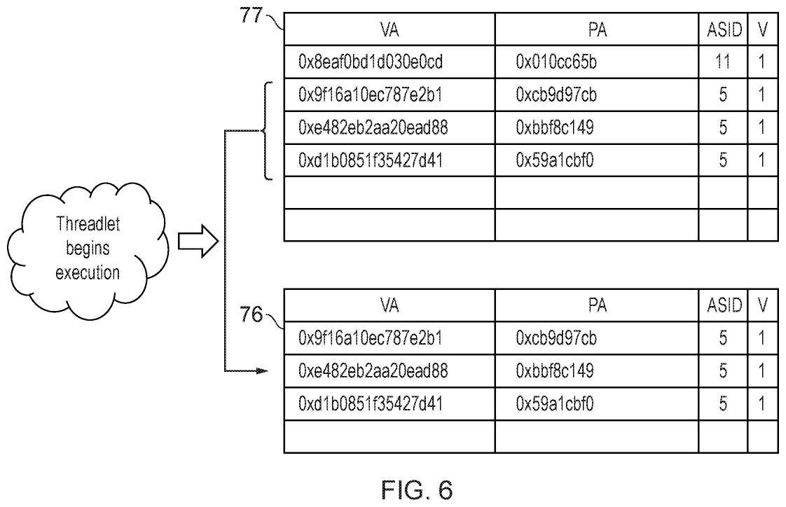

FIG. 6 illustrates an example of a TLB provided for a CPU and also a TLB provided for the TE;

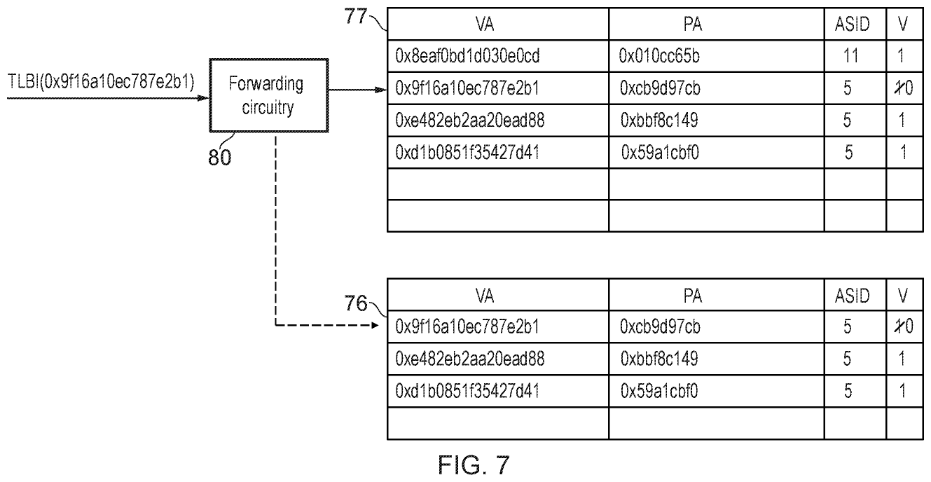

FIG. 7 illustrates forwarding circuitry that is used for handling invalidation commands in both of the TLBs;

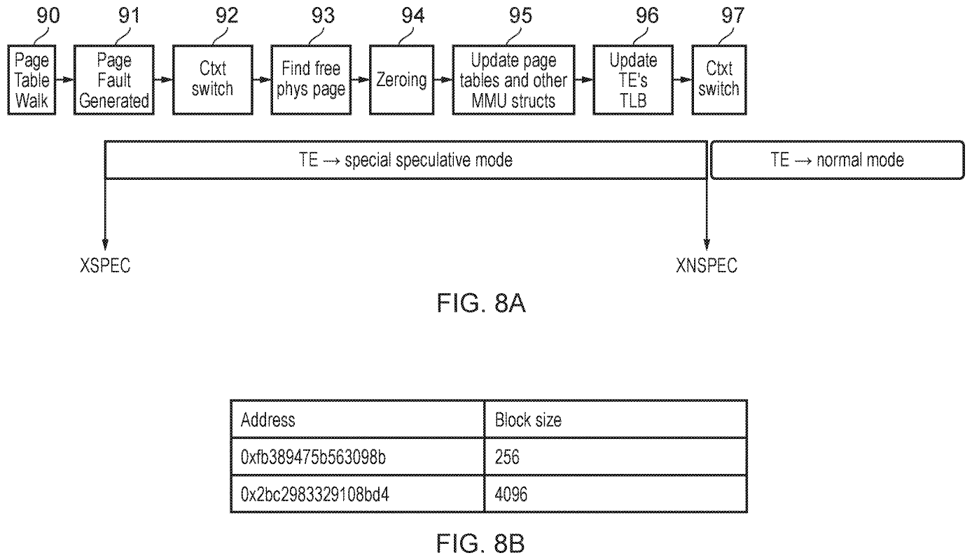

FIG. 8A illustrates a process that can be used in order to prevent a TE stalling in response to a minor page fault;

FIG. 8B illustrates a data structure that can be used by supervisor software such as an operating system to detect lazy allocations;

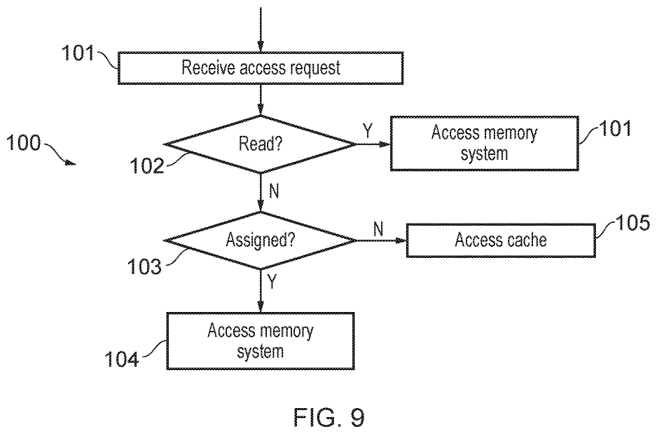

FIG. 9 illustrates the behaviour of the speculative mode in the form of a flowchart;

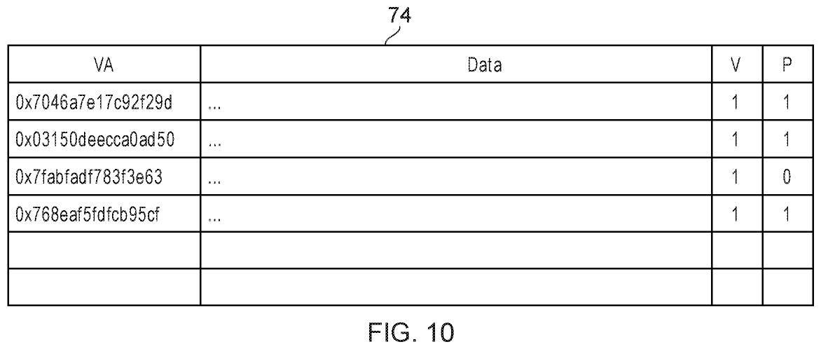

FIG. 10 illustrates an example of a cache that can be used with the speculative mode of operation;

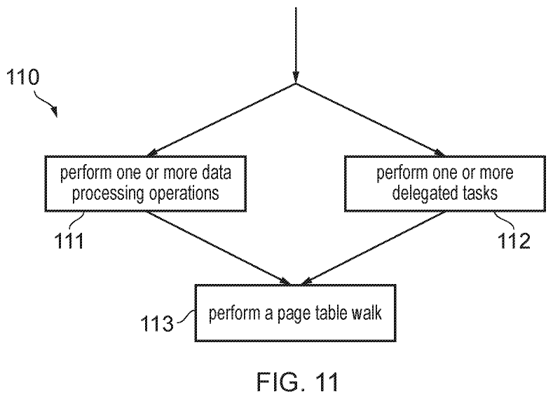

FIG. 11 provides a flowchart that shows a method of data processing in accordance with some examples; and

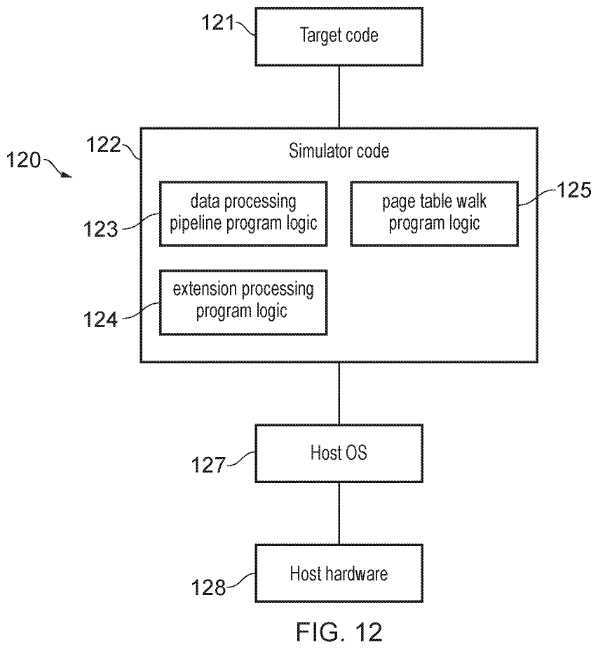

FIG. 12 illustrates a simulator implementation that may be used.

Before discussing the embodiments with reference to the accompanying figures, the following description of embodiments and associated advantages is provided.

In accordance with one example configuration there is provided an apparatus for data processing, comprising: a data processing pipeline configured to perform one or more data processing operations; extension processing circuitry associated with the data processing pipeline and configured to perform one or more delegated tasks; and page table walk circuitry configured to perform a page table walk operation on memory in response to either the one or more data processing operations or the one or more delegated tasks, wherein the extension processing circuitry is configured to perform the one or more delegated tasks asynchronously to the one or more data processing operations performed by the data processing pipeline.

An apparatus comprising a data processing pipeline can be required to perform a limitless variety of data processing operations as defined by the sequence of instructions provided to it. In order efficiently to perform those data processing operations, the data processing pipeline may be configured with a variety of functional units, each with a given specialised type of data processing ability, such as arithmetic logic units (ALUs), floating point (FP) units, load/store units, and so on. Yet even with such specialised functional units being provided as part of the data processing pipeline, the inventors of the present techniques have established that in some types of data processing, that is in certain programs (i.e. sequences of instructions), there can be particular functions which are frequently executed and which require an amount of processing, such that the provision of custom hardware dedicated to supporting these functions is worthwhile, since it could significantly impact the overall performance of the apparatus. In identifying such functions, two key properties were deemed to be relevant: a function's ubiquity (i.e. it can also be found in the many other use-cases) and a function's impact (i.e. the proportion of time spent executing such a function is a significant percentage of the overall runtime, such that improvements in its execution made a significant difference to the overall use-case). Such impactful, ubiquitous functions have been found to include tasks or functions such as memcpy, memset, compression, encryption, and string processing, although the present techniques are not limited to these particular examples. The present techniques provide extension processing circuitry that is associated with the data processing pipeline and is configured to set up such a function (a delegated task) for later execution, the delegated task being received from the data processing pipeline. Such extension processing circuitry may also be referred to as a threadlet extension (TE) herein. The sequence of operations it carries out to perform the defined function may also be referred to as a threadlet herein. The extension processing circuitry, although closely associated (tightly coupled) with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The asynchronous operation of the extension processing circuitry with respect to the data processing pipeline is possible because, unlike some prior art techniques, the extension processing circuitry receives a directive or command from the thread currently executing on the CPU and performs the required operations independently, that is without requiring a stream of instructions from the CPU that directly control or influence its internal operation. The CPU is therefore free to continue executing other code and potentially reduce overall runtime by overlapping the execution of the instruction stream after the directive or command is sent to the extension processing circuitry with the operation of the extension processing circuitry. In these examples, page table walk circuitry is provided in order to perform a page table walk. This occurs when a translation from a virtual address to a physical address (or intermediate virtual address) is not available in, for instance, a translation lookaside buffer, and a page table walk must occur in order to locate and/or determine the translation. In these examples, rather than providing separate page table walk circuitry, a single circuit is provided that can be engaged by either the extension processing circuitry or the data processing pipeline. This improves efficiency since in many cases, a page table walk performed by one of the extension processing circuitry and the page table walk circuitry will be beneficial to the other. In addition, it helps to reduce the amount of circuitry required, thereby saving circuit space and power consumption.

In some examples, the data processing pipeline comprises a pipeline translation lookaside buffer and the extension processing circuitry comprises an extension translation lookaside buffer. As explained above, a translation lookaside buffer or TLB is used to cache translations from a virtual address space to a physical address space so that a page table walk need not be provided each time a translation is required. Since a page table walk can be time consuming, such caches can improve efficiency. In these examples, by providing each of the data processing pipeline and the extension processing circuitry with its own TLB, the two devices are able to work more asynchronously. In particular, since the extension processing circuitry has its own private cache of translations in its TLB, it is able to access these more quickly than would be possible if it were required to access the TLB of the data processing pipeline. In addition, by storing the translations used by the extension processing circuitry in its own TLB, it is possible to reduce any impact on the pipeline's processing and in particular its load/store datapath. For instance, it is less likely that translations required by the data processing pipeline will be evicted by translations required by the extension processing circuitry.

In some examples, the page table walk circuitry is configured, in response to the page table walk operation being performed in response to one of the one or more delegated tasks, to add a translation entry to the extension translation lookaside buffer without adding the translation entry to the pipeline translation lookaside buffer. In these examples, when a page table walk is signalled or caused by one of the delegated tasks (e.g. on the TE) then any translation that is obtained is added to the TLB of the TE without adding the entry to the TLB of the CPU (e.g. the data processing pipeline).

In some examples, the page table walk circuitry is configured, in response to the page table walk operation being performed in response to one of the one or more delegated tasks, to add a translation entry to the extension translation lookaside buffer and the pipeline translation lookaside buffer. In these examples, in addition to storing the translation entry in the TLB of the TE, the same translation entry is stored in the TLB of the CPU (data processing pipeline) as well. This can be useful where it is likely that the translation that is requested by the delegated task will be useful to both the CPU and the TE and to the processes executing on them.

In some examples, the page table walk circuitry is configured to add the translation to the pipeline translation lookaside buffer in dependence on a condition.

In some examples, the pipeline translation lookaside buffer and the extension processing circuitry translation lookaside buffer are both configured to store translations from a same virtual address space to a same physical address space of the memory. In other words the virtual address space used for each of the translation lookaside buffers is the same, and also the physical address space used in each of the translation lookaside buffers is the same. Consequently, exactly the same translation can be used in either translation lookaside buffer without any of the addresses in the translation needing further translation in order to be usable in that TLB. Another way of viewing this is that the same virtual and physical addresses used by the TE are equally valid to the CPU and will point to the same areas of memory.

In some examples, at least one of the pipeline translation lookaside buffer and the extension processing circuitry translation lookaside buffer comprises forwarding circuitry to perform forwarding of an invalidation command to the other of the pipeline translation lookaside buffer and the extension processing circuitry translation lookaside buffer. Invalidation commands are used to remove or invalidate entries from a TLB. This might happen if the ownership or location of memory is changed, for instance. In order to help prevent stale entries from being formed in each of the TLBs, when an invalidation command to invalidate entries in one of the two TLBs is received, forwarding circuitry is used to forward it to the other of the TLBs.

In some examples, the forwarding is performed on a condition that the other of the pipeline translation lookaside buffer and the extension processing circuitry translation lookaside buffer could contain an entry referenced by the invalidation command. In these examples, the forwarding is performed if that other TLB might have an entry that would also be subject to the invalidation command. That is, if an invalidation command is received by the pipeline translation lookaside buffer to invalidate a virtual address 0x0ff03bc0 then if the extension processing circuitry TLB might also contain an entry for that address then the invalidation command will also be forwarded to the extension processing circuitry TLB. Whether or not such an entry is likely to be present could be determined by tracking which entries are copied between the TLBs (e.g. when a threadlet begins and stops execution) and simply assuming that if an entry was copied to the other TLB then the translation could still be present. In other examples, each of the TLBs may be assigned a particular region of memory in which to operate. The TLB(s) could assume that any invalidation command directed towards an area of memory belonging to one of the TLBs could affect a translation in that TLB and therefore forward the invalidation command.

In some examples, in response to one of the one or more delegated tasks, the extension processing circuitry is configured to receive at least a subset of entries from the pipeline translation lookaside buffer. In these examples the beginning of a delegated task causes entries to be copied from the pipeline translation lookaside buffer to the extension. In some situations, this may only be a subset of the entries in the pipeline TLB (particularly if the pipeline TLB happens to be bigger than that of the extension processing circuitry TLB). The beginning of a delegated task could be when the task is actually delegated (e.g. by the CPU) or could be when the delegated task begins execution.

In some examples, the at least a subset of entries are indicated by an Address Space Identifier. Also in some examples, the at least a subset is at most a subset. Address Space Identifiers (ASID) can be used to distinguish different applications to which address translations are used. The ASID can therefore be used as an indicator to refer to a grouping of related (or potentially related) address translations.

In some examples, the page table walk operation is performed in respect of a virtual address; and the virtual address is accessed as part of the one or more data processing operations or the one or more delegated tasks. Typically a page table walk operation is performed in order to locate the physical address to which a virtual address belongs. The virtual address could be used by either of the one or more data processing operations that execute on the CPU or by the one or more delegated tasks that execute as a threadlet on the TE.

In some examples, the data processing pipeline is configured, in response to the page table walk operation occurring in response to the one or more delegated tasks and the page table walk operation determining that no valid or suitable memory page has been allocated to the virtual address, to allocate a memory page to the virtual address. Sometimes, a lazy memory allocation may take place. For instance, when an application requests a block of memory (e.g. via a malloc call), the operating system may allocate virtual memory to the application without the underlying physical memory being allocated or set up for use. Then, when the allocated memory is actually used, a minor page fault occurs because it is realised (either through a page table walk failing to return a valid or suitable entry and/or tracking and/or some marking process) that the underlying physical memory has not been allocated and set up for use by the application. The set up process could involve, for instance, zeroing or at least clearing the content of the memory so that a previous application's use of that memory cannot be read by the new application to which the memory has been allocated. In these situations where the delegated task, which runs on the TE, cause such a minor page fault, it is the CPU (e.g. via an operating system or other supervisor software executing on the CPU) that deals with allocating the physical memory to the virtual memory and then causing the physical memory to be set up for the delegated task to execute. Another situation in which this can arise is certain copy-on-write mechanisms in which a copy of some data is requested and no modification is (yet) made to it. In this situation, no memory may actually be allocated until such time as a modification is made to the data. Again, the first time a write is made to the data, it will be determined that no physical memory is allocated and the operating system or other supervisor software will intervene to rectify the problem.

In some examples, the data processing pipeline is configured, in response to the page table walk operation occurring in response to the one or more delegated tasks and the page table walk operation determining that no valid or suitable memory page has been allocated to the virtual address, to cause the extension processing circuitry to enter a speculative mode of operation and to execute at least part of the delegated task in the speculative mode of operation. Rather than waiting for the previously described minor page fault to be solved—i.e. rather than waiting for physical memory to be assigned to the virtual memory that was assigned to the threadlet—the threadlet continues its execution in a speculative mode of operation. Speculative modes of operation typically allow execution to operate in a limited capacity—perhaps with the restriction that any state changes that are made are kept local and are not transmitted further until the source of the speculation is resolved.

In some examples, the data processing pipeline is configured, in the speculative mode of operation, to write data to an internal buffer when the data is addressed to the memory page. One specific way in which the speculative mode of operation can proceed is through the writing of data. This is because writing data (e.g. to a memory system) fundamentally causes a change in state—something that is not true of reading data. Consequently in these examples, attempts to write to a virtual address where no physical page has been assigned, causes the data to be written to an internal buffer rather than being propagated back to the memory system. This means that the written data cannot be accessed by other systems (such as the CPU) at least until the speculative mode of operation ends. In some examples, the internal buffer could be a cache that is private to the TE.

In some examples, the data processing pipeline is configured, in response to a valid or suitable memory page being allocated to the virtual address, to cause the extension processing circuitry to execute at least part of the delegated task in a non-speculative mode of operation. Consequently, once the physical memory has been assigned, the speculative mode of operation can end and data that was speculatively written (e.g. to the internal buffer) can be permitted to propagate so that it can be accessed by other systems such as the CPU.

In some examples, the extension processing circuitry comprises a cache configured to store the data in association with a flag to indicate whether the data can be propagated to other memory devices; and when the data has been written speculatively, the flag is set to indicate that the data is prohibited from being propagated to the other memory devices; and when the speculative mode of operation ends, the flag is set to indicate that the data is permitted to be propagated to the other memory devices. In these examples, the cache acts as the previously described internal buffer. It is assumed that the cache is private to the TE and so cannot be accessed by the CPU thus keeping any state in the cache private to the TE and (provided data is not pushed up to a shared cache or memory) fulfilling the requirement that any speculative data is kept private and not distributed. The data can be prevented from being pushed up to a shared cache or memory by setting a flag to indicate whether the data can be propagated or not.

In some examples, the data processing pipeline is configured, in the speculative mode of operation, to perform writes outside the memory page non-speculatively. It will be appreciated that there may be no need to perform speculative writes outside the memory page for which no physical memory has been assigned since it is only these writes that should not yet be propagated.

In some examples, the data processing pipeline is configured, in the speculative mode of operation, to perform reads non-speculatively. Of course, it is generally also the case that reads do not result in changes of state and consequently reads can proceed non-speculatively as well. Where a read occurs to a virtual address that has no corresponding physical address, the read can be handled by, for instance, the cache or other private buffer where the speculatively written data has been kept. Otherwise, the request can be propagated through the memory system to locate the requested data.

In some examples, the apparatus comprises: decode circuitry configured to respond to a mode change instruction to control whether the extension processing circuitry operates in the speculative mode of operation.

In some examples, the data processing pipeline is configured to track when the memory page has been allocated to the virtual address. This might be performed by supervisor software such as, for instance, an operating system.

In some examples, the apparatus comprises: decode circuitry configured to respond to a mode change instruction to control whether the extension processing circuitry operates in a speculative mode of operation. In some examples, the instruction could indicate whether it is safe (permitted) to enter the previously described speculative mode of operation independently of whether a page fault has actually occurred or not. For example, this would allow the apparatus to enter the speculative mode for some other reason or even for the apparatus to enter the speculative mode of operation if a page fault were later to occur. Then, if a page fault occurs, and it is permitted, the apparatus can be changed into the speculative mode of operation. Any delegated task that was being executed can then execute in the speculative mode. This can continue until the page fault is resolved or until a further instruction indicates that the speculative mode is no longer permitted.

Particular embodiments will now be described with reference to the figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task is generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which an extension processing circuitry (TE) transitions in some examples. Initially the TE is in an IDLE state 60. When an extension start (XSTART) instruction is encountered by the data processing pipeline, a delegation signal can cause the TE to switch to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. An indication of the source of the fault is placed in a special syndrome system register, the address associated with the fault is stored in the fault address system register, and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  ...
  XSTART {x0 − x3}, #imm_op / / funcX (a, b, c, d) ;
  I1
  I2
  I3
  I4
  ...
  XSYNC x0, #imm_op
  ...
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions 11, 12, 13, 14, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim).

For efficiency and to help provide a more seamless transfer of data and interoperability between the CPU 51 and the TE 52, it is desirable for the CPU 51 and the TE 52 to issue memory requests in the same virtual address space. In particular, this makes it possible for data and address translations to be freely interchanged between the CPU 512 and TE 52 without having to translate from one virtual address space to another.

FIG. 5 illustrates a variant of the apparatus previously illustrated in FIG. 3. In this example, the CPU 71 continues to execute a series of instructions including memory access instructions which access memory locations. The data for those locations may be stored within a L1 cache 73 that is private to the CPU 71, or could be stored in a shared L2 cache 75 or even a main memory (not pictured). The TE 72 asynchronously executes instructions or tasks as previously described. It also has access to a private L1 cache 74 of its own, but can also access data in the shared L2 cache 75. As previously described, the CPU 71 has a translation lookaside buffer 77 used for providing translations from virtual addresses to physical addresses and the TE 72 has its own private TLB 76 as well. Data may be exchanged between these TLBs 76, 77 as will be described below. The CPU also includes page table walk circuitry 78, which can be used to obtain a translation from a virtual address to a physical address when the translation is not provided in the TLB 77 belonging to the CPU 71. In these examples, however, the TE is also able to make use of the page table walk circuitry 78 belonging to the CPU 71 in order to perform a page walk. Since both devices operate in the same virtual address space, any translation obtained by either the CPU 71 invoking the page table walk circuitry 78 or the TE invoking the page table walk circuitry 78 could be used by the other device.

Note that in this example, the page table walk circuitry 78 is shown as belonging to the CPU 71. In practice, however, the page table walk circuitry 78 could belong to the TE 72 (and still shared with the CPU 71) or the page table walk circuitry 78 could be central and not strictly belong to either device 71, 72.

When the page table walk circuitry 78 performs a page walk and determines a translation, the translation may be stored into one or both of the TLBs 76, 77. In some examples, the translation is stored only into the TLB 76, 77 that initiates the page table walk. In other examples, the translation might always be stored in the TLB 77 that is most local to the page table walk circuitry 78. In other examples, the translation is stored in both TLBs 71, 72. In some examples, whether or not the translation is stored in the secondary TLB is dependent on some condition. For instance, this might be that the secondary TLB has spare capacity (e.g. it will not be necessary for a valid entry to be displaced).

In a situation in which both the TLBs 76, 77 indicate that a page table walk is to occur simultaneously, the page table walk circuitry 78 can either prioritise one of the CPU 71 or the TE 72 or in some embodiments, may serve each of the CPU 71 and the TE 72 in a round-robin fashion.

FIG. 6 illustrates an example of a TLB 77 provided for a CPU and also a TLB 76 provided for the TE. In each case, the TLBs provide a translation from a virtual address (VA) to a physical address (PA) although it will be appreciated that in practice, TLBs might also provide translations from virtual addresses to intermediate virtual addresses instead. The exact nature of the translation is largely immaterial. Each entry in the TLBs 76, 77 is also associated with an Address Space Identifier (ASID), which can be used to indicate an application with which the address translation is associated. Each address translation also has a validity flag (V) that indicates whether the translation is valid or not.

In this example, as a threadlet begins execution, a portion of the TLB 77 belonging to the CPU 71 (specifically those having an ASID of 5) is copied to the TLB 76 provided for the TE 72. There are a number of ways in which the copying can be achieved. In some examples, if the TLB provided for the TE 72 is suitably sized then the entirety of the TLB 77 of the CPU 71 can be copied. In this example, however, the entries in the TLB 76 of the TE 72 that are associated with the task that is to be run (based on the ASID value) are copied to the TLB 76 of the TE 72.

FIG. 7 illustrates forwarding circuitry 80 that is used for handling invalidation commands in both of the TLBs 76, 77. Typically, a TLB invalidation (TLBI) will be sent to a CPU 71 from e.g. another CPU in order to indicate that ownership of the memory has changed or perhaps that memory has moved, or even that the memory location is no longer valid (e.g. an application ended). In these situations, an invalidation command is issued so that translations from the virtual address to the physical address can be invalidated. The command is then sent to the TLB in order to cause any such stored translations to be invalidated. In these situations, forwarding circuitry 80 can be used to forward the invalidation command so that invalid translations in either of the TLBs is invalidated. The forwarding of the invalidation command by the invalidation circuitry 80 can be dependent on whether the invalidation could affect any entries of the other TLB 76. For example, the forwarding circuitry may note that entries having an ASID of 5 were previously copied and therefore might only forward invalidation commands where the virtual address also has an ASID of 5. Note that it need not be the case that a translation is actually stored in the TLB 76 being forwarded to, merely that there has been a determination such a translation could be there (e.g. based on previous knowledge). In some situations, for safety, all invalidation commands are forwarded by the forwarding circuitry 80 to both TLBs 76, 77.

In some situations, the page table walk could result in a fault. One such type of fault, a minor page fault, that can occur is when the memory allocation system allocates physical memory in a lazy manner. For example, a process might request a block of memory via a malloc request. This can be dealt with by the operating system or other supervisor software (e.g. a hypervisor) by immediately allocating a block of virtual memory without actually connecting any physical memory to it with the intention of allocating the physical memory at a later time when the memory is actually accessed. This can make sense since there may be a large gap between the memory being requested and the memory actually being used in which the situation regarding the memory layout might change. Regardless when a request is then made to access the memory, a page fault will be raised because there is no underlying physical memory to be accessed yet.

Where the page table walk is being performed as a consequence of the TE 72, this might ordinarily lead to a stall as the physical memory is allocated and any other setup procedures (e.g. zeroing the memory so that the previous owner's data cannot be accessed) is performed by, e.g. the operating system.

In any event, the receiver(s) of the TLBI will need to provide an acknowledgement of receipt of the TLBI. Typically a software program (e.g. an operating system) that issues the invalidation is not able to proceed until the invalidation is acknowledged. The issuing of the invalidation command can therefore act as a barrier. This helps to avoid stale translations being used.

FIG. 8A illustrates a process that can be used in order to prevent a TE 72 stalling in response to a minor page fault. At a step 90, the page table walk is performed in order to locate a physical address for an (allocated) virtual address and at a step 91, the (minor) page fault is generated. This results in a context switch occurring on the CPU 71 to enable the operating system to respond at step 92. At a step 93, the operating system finds a free physical page to be allocated to the virtual memory that was being accessed. At a step 94, the physical memory area is zeroed so as to erase any previous usage (e.g. from another application) so that the previous data is kept secure. At a step 95, the page tables and other memory management unit (MMU) structures are updated to reflect the new mapping. Then at step 96, the TLB 76 belonging to the TE 72 is updated. Finally, a context switch (e.g. back to the previous application that was running when the operating system was interrupted) occurs at step 97.

While the TE 72 is waiting for the physical memory to become available, the TE 72 might stall in its execution, which is clearly undesirable. In order to avoid this happening, from the time that the minor page fault is generated at step 91 until the final context switch happens at step 97, the TE 72 can be put in to a special speculative mode that allows execution to continue while limiting the access to memory. After the final context switch occurs at step 97, the TE 72 can return to its normal non-speculative mode.

The switches to the speculative mode can be achieved by the issuing of an XSPEC instruction by the operating system. When decoded by the decode circuitry 13 of the pipeline, this causes a mode change in the TE 72. In contrast, the mode change back to the non-speculative mode can be achieved by the issuing of an XNSPEC instruction. Note that it need not be necessary to provide a separate instruction. In some embodiments, each time the XSPEC instruction is issued, the mode of the TE alternates, thereby switching between speculative and non-speculative.

The XSPEC instruction can be issued by the operating system (e.g. after the context switch to the operating system has been performed) and can be disabled by the operating system (e.g. before the context switch back to the ‘current’ application is performed). However, there are other alternatives to this behaviour. In some examples, the speculative mode can be switched on and off via the context switch code itself (e.g. by issuing the XSPEC instruction). In the example of FIG. 8A, the speculative mode is entered as part of the page fault generation itself. After the XSPEC instruction is encountered for a page fault emanating from the activity of a given thread, the location of the thread stack can be cached in the TE 72. During future page faults with the same or similar thread stack, the speculative mode can be entered automatically (e.g. as a result of the XSPEC instruction being activated by the page table walk circuitry 78). This allows the speculative mode to operate for a longer period.

FIG. 8B illustrates a data structure that can be used by supervisor software such as an operating system to detect lazy allocations and to respond with the mechanism illustrated in FIG. 8A when an attempt is made to access lazily allocated memory. In this example, the data structure takes the form of a table containing a virtual memory address and an allocation block. When an operation is performed that causes a virtual memory address to be provided without any backing storage (e.g. physical memory) being assigned, an entry is added to the table. When a page fault (e.g. a minor page fault) occurs, which causes the operating system to intervene, the operating system firstly determines the nature of the page fault from any signal that is produced (e.g. from the memory system or the page table walk circuitry) to indicate the nature of the fault. If the fault is that no underlying physical memory could be located then the operating system determines whether the virtual address being accessed falls within one of the memory ranges defined in the table. If so, then it can be determined that the minor page fault has occurred likely as a consequence of no physical storage having been allocated. In that case, the process outlined in FIG. 8A can be followed. When the physical memory is allocated (either due to the process in FIG. 8A or due to some other cleanup operation) then the relevant entry can be deleted from the table shown in FIG. 8B. It will be appreciated that the data structure shown in FIG. 8B also helps with steps 93 and 94 for finding and zeroing the physical memory since the operating system can determine how much memory to allocate and zero.

FIG. 9 illustrates the behaviour of the speculative mode in the form of a flowchart 100. At a step 101, a memory access request is received. At a step 102, it is determined if the memory access request is a read request (as opposed to a write request). If the request is a read request then at step 101, the memory system is accessed in the usual manner. That is to say that the part of the memory system containing the most recent version of the data is accessed whether that is a cache or a main memory is accessed in order to obtain the data. Alternatively, if the request is a write request then at step 103 it is determined whether the data being written is to a memory location for which a minor fault has been raised. This can be determined either by tracking the minor page faults or it can be specified as part of the XSPEC instruction itself. In any event, if there is an assigned physical page that has been appropriately allocated then the memory system can also be accessed in the usual way at step 104. Alternatively, if there is no assigned physical page then at step 105 the local cache (or other provided internal buffer) can be accessed with the written data being confined to the cache or other provided internal buffer until such time as the speculative mode is disabled. Flags in the cache (illustrated in FIG. 10) can be set to prevent the data propagating further than the cache.

FIG. 10 illustrates an example of a cache 74 that can be used with the speculative mode of operation. Each entry has a virtual address (VA) associated with data that is to be stored at that virtual address. In addition, a validity flag is set or cleared depending on whether that entry is currently valid or has been invalidated (e.g. via the previously described invalidation command). In addition a flag ‘P’ is provided to indicate whether the data is permitted to be propagated to the rest of the memory system. A write to a location that is not physically mapped results in the data being written to the cache 74 with the ‘P’ flag set due to the speculative mode being set (as previously discussed in respect of FIG. 9). When the speculative mode ends, the P flag is cleared and the data is then permitted to propagate to the rest of the memory system (e.g. when entries are evicted and replaced).

In some embodiments, the speculative mode may be set in relation to multiple different areas of memory. In these examples, the ‘P’ flag can be replaced with a ‘P’ value. When a memory allocation occurs, the speculative mode is enabled as usual and any attempt to write to the virtual address results in an entry being written to the cache 74 as already described. In these instances though, the P value is set to a value that indicates which memory allocation is being waited upon. When that memory allocation occurs any matching entries in the cache have the ‘P’ value reset and they are permitted to have their value propagated throughout the memory system. Meanwhile, other entries that are awaiting other memory allocations remain restricted to the cache 74.

FIG. 11 provides a flowchart 110 that shows a method of data processing in accordance with some examples. The process involves the execution of one or more data processing operations (e.g. in a data processing pipeline or CPU 71) at step 111 and this occurs asynchronously with the execution of one or more delegated tasks (e.g. in a threadlet extension or TE 72) at step 112. Either or both of these processes can result in a page table walk being requested at step 113. The circuitry used for the page table walk can be specific to one of the data processing pipeline 71 or the threadlet extension 72.

FIG. 12 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 128, optionally running a host operating system 127, supporting the simulator program 122. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 122 may be stored on a computer-readable storage medium (which may be a non-transitory medium), and provides a program interface (instruction execution environment) to the target code 121 (which may include applications, operating systems and a hypervisor) which is the same as the interface of the hardware architecture being modelled by the simulator program 122. Thus, the program instructions of the target code 121 may be executed from within the instruction execution environment using the simulator program 112, so that a host computer 128 which does not actually have the hardware features of the apparatuses 10, 30, 50, 70 discussed above can emulate these features. In particular, the simulator program 122 may include data processing pipeline program logic 123 for emulating the behaviour of the data processing pipeline 71, extension processing program logic 124 for emulating the behaviour of the extension processing circuitry 72 and page table walk program logic 125 for emulating the behaviour of the page table walk circuitry 78.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus for data processing, comprising:
a data processing pipeline configured to perform one or more data processing operations;
extension processing circuitry associated with the data processing pipeline and configured to perform one or more delegated tasks; and
page table walk circuitry configured to perform a page table walk operation on memory in response to either the one or more data processing operations or the one or more delegated tasks, wherein
the extension processing circuitry is configured to perform the one or more delegated tasks asynchronously to the one or more data processing operations performed by the data processing pipeline.

2. The apparatus according to claim 1, wherein
the data processing pipeline comprises a pipeline translation lookaside buffer and the extension processing circuitry comprises an extension translation lookaside buffer.

3. The apparatus according to claim 2, wherein
the page table walk circuitry is configured, in response to the page table walk operation being performed in response to one of the one or more delegated tasks, to add a translation entry to the extension translation lookaside buffer without adding the translation entry to the pipeline translation lookaside buffer.

4. The apparatus according to claim 2, wherein
the page table walk circuitry is configured, in response to the page table walk operation being performed in response to one of the one or more delegated tasks, to add a translation entry to the extension translation lookaside buffer and the pipeline translation lookaside buffer.

5. The apparatus according to claim 4, wherein
the page table walk circuitry is configured to add the translation to the pipeline translation lookaside buffer in dependence on a condition.

6. The apparatus according to claim 2, wherein
the pipeline translation lookaside buffer and the extension processing circuitry translation lookaside buffer are both configured to store translations from a same virtual address space to a same physical address space of the memory.

7. The apparatus according to claim 6, wherein
at least one of the pipeline translation lookaside buffer and the extension processing circuitry translation lookaside buffer comprises forwarding circuitry to perform forwarding of an invalidation command to the other of the pipeline translation lookaside buffer and the extension processing circuitry translation lookaside buffer.

8. The apparatus according to claim 7, wherein
the forwarding is performed on a condition that the other of the pipeline translation lookaside buffer and the extension processing circuitry translation lookaside buffer could contain an entry referenced by the invalidation command.

9. The apparatus according to claim 2, wherein
in response to one of the one or more delegated tasks, the extension processing circuitry is configured to receive at least a subset of entries from the pipeline translation lookaside buffer.

10. The apparatus according to claim 9, wherein
the at least a subset of entries are indicated by an Address Space Identifier.

11. The apparatus according to claim 1, wherein
the page table walk operation is performed in respect of a virtual address; and
the virtual address is accessed as part of the one or more data processing operations or the one or more delegated tasks.

12. The apparatus according to claim 11, wherein
the data processing pipeline is configured, in response to the page table walk operation occurring in response to the one or more delegated tasks and the page table walk operation determining that no valid or suitable memory page has been allocated to the virtual address, to allocate a memory page to the virtual address.

13. The apparatus according to claim 11, wherein
the data processing pipeline is configured, in response to the page table walk operation occurring in response to the one or more delegated tasks and the page table walk operation determining that no valid or suitable memory page has been allocated to the virtual address, to cause the extension processing circuitry to enter a speculative mode of operation and to execute at least part of the delegated task in the speculative mode of operation.

14. The apparatus according to claim 13, wherein
the data processing pipeline is configured, in the speculative mode of operation, to write data to an internal buffer when the data is addressed to the memory page.

15. The apparatus according to claim 10, wherein
the data processing pipeline is configured, in response to a valid or suitable memory page being allocated to the virtual address, to cause the extension processing circuitry to execute at least part of the delegated task in a non-speculative mode of operation.

16. The apparatus according to claim 13, wherein
the extension processing circuitry comprises a cache configured to store the data in association with a flag to indicate whether the data can be propagated to other memory devices; and
when the data has been written speculatively, the flag is set to indicate that the data is prohibited from being propagated to the other memory devices; and
when the speculative mode of operation ends, the flag is set to indicate that the data is permitted to be propagated to the other memory devices.

17. (canceled)

18. (canceled)

19. (canceled)

20. (canceled)

21. The apparatus according to claim 1, comprising:
decode circuitry configured to respond to a mode change instruction to control whether the extension processing circuitry operates in a speculative mode of operation.

22. A method of data processing, comprising:
performing, on a data processing pipeline, one or more data processing operations;
performing, on extension processing circuitry associated with the data processing pipeline, one or more delegated tasks; and
performing a page table walk operation on memory in response to either the one or more data processing operations or the one or more delegated tasks, wherein
the extension processing circuitry is configured to perform the one or more delegated tasks asynchronously to the one or more data processing operations performed by the data processing pipeline.

23. A non-transitory computer-readable medium to store a computer program for controlling a host data processing apparatus to provide an instruction execution environment comprising:
data processing pipeline program logic configured to set up one or more data processing operations;
extension processing program logic associated with the data processing pipeline program logic and configured to set up one or more delegated tasks; and
page table walk program logic, configured to perform a page table walk operation on memory in response to either the one or more data processing operations or the one or more delegated tasks, wherein
the extension processing program logic is configured to perform the one or more delegated tasks asynchronously to the one or more data processing operations performed by the data processing pipeline.

24. A non-transitory computer-readable medium to store computer-readable code for fabrication of an according to claim 1.
